(19) United States
(12) Patent Application Publication
(10) Pub. No.: US 2026/0197320 A1
(43) Pub. Date: Jul. 9, 2026

(54) COMMUNICATING COMPUTE ENTITY ROLE INFORMATION AMONG NETWORK DEVICES

(71) Applicant: HEWLETT PACKARD ENTERPRISE DEVELOPMENT LP, Spring, TX (US)

(72) Inventors: Vikas Kumar Pareek, Bangalore (IN); Somanath Yadavalli, Bangalore (IN); Dhanesh Kumar Dhanesh Kumar, Bangalore (IN); Ramesh Muthuraj, Bangalore (IN)

(21) Appl. No.: 19/085,430

(22) Filed: Mar. 20, 2025

(30) Foreign Application Priority Data
Jan. 7, 2025 (IN) 202541001420

(51) Int. Cl. H04L 9/40

(52) U.S. Cl. CPC H04L 63/104; H04L 63/0876; H04L 63/20

(57) ABSTRACT

In some examples, a first network device receives, from a second network device, role update information for a compute entity connected to the second network device, the role update information including role information specifying a role of the compute entity and a network address of the compute entity. The first network device updates role mapping information stored at the first network device based on the received role update information, where the role mapping information correlates network addresses to roles. The first network device receives, from a first compute entity, a data packet containing a destination network address of a second compute entity to which the data packet is targeted. The first network device performs a lookup of the role mapping information using the destination network address to determine a role of the second compute entity, and enforces a policy with respect to the data packet at the first network device based on a role of the first compute entity and the role of the second compute entity.

### BACKGROUND

Compute entities can communicate with one another or access resources in a network environment. The compute entities can be divided into multiple groups according to roles of the compute entities. Group-based policies associated with corresponding groups of compute entities can be applied at enforcement points in the network environment.

### BRIEF DESCRIPTION OF THE DRAWINGS

Some implementations of the present disclosure are described with respect to the following figures.

FIG. 1 is a block diagram of an arrangement that includes network devices capable of sharing role information of compute entities, according to some examples.

FIG. 2 is a flow diagram of a process involving compute entities and network devices, in accordance with some examples.

FIG. 3 is a block diagram of a storage medium storing machine-readable instructions according to some examples.

FIG. 4 is a block diagram of a network device according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Group-based policies that are applied with respect to respective groups of compute entities can control the way the compute entities are able to communicate in a network environment, what resources are accessible by the compute entities, actions that may be taken by the compute entities, or other aspects of the compute entities. A compute entity can include an electronic device or a virtual compute entity such as a virtual machine (VM) or a container. To determine which group a particular compute entity is to be assigned, a role of the particular compute entity is determined. A “role” of a compute entity can refer to a property (or properties) of the compute entity, and/or of a user of the compute entity. For example, a role of the compute entity can include any or some combination of the following: a guest role (indicating that the compute entity is associated with a user that is visiting the network environment), an employee role (indicating that the compute entity is associated with a user that is an employee of an organization), a role of a specific department within an organization (indicating that the compute entity is associated with a user that works in the specific department), a responsibility or assigned function of the compute entity, a capability of the compute entity, or any other characteristic of the compute entity

A network includes network switches (or more simply “switches”) through which data packets are transferred. A source compute entity that transmits a data packet may be connected to an ingress switch, while a destination compute entity to which the data packet is targeted may be connected to an egress switch. The ingress switch is the switch at which a data packet transmitted by the source compute entity is received to forward over the network, and the egress switch is the switch at which the data packet transmitted over the network is received for forwarding to the destination compute entity. In some examples, role-to-role policy enforcement can be applied at the egress access switch, in which the group-based policy to apply is determined based on a source role of the source compute entity and a destination role of the destination compute entity. Performing policy enforcement at the egress access switch can be inefficient, since the data packet has to traverse across the network to the egress access switch to determine what group-based policy is applied. If the applied group-based policy indicates that the data packet is to be dropped, then the transmission of the data packet across the network has consumed network resources unnecessarily. A large quantity of data packets (from many compute entities) that are ultimately dropped due to policy enforcements at egress access switches can use up a significant portion of the network bandwidth, which can result in reduced network bandwidth availability or reduced data rates for data communications across the network.

In accordance with some implementations of the present disclosure, role-based policy enforcement can be applied at an ingress network device that received a data packet from a source compute entity based on determining a source role of the source compute entity using a tag in the data packet, and determining a destination role of a destination compute entity using role mapping information stored at the ingress network device. The ingress network device updates the role mapping information stored at the ingress network device in response to role update messages containing role information of compute entities received from one or more other network devices. The role update messages are used by network devices to share role information of new compute entities as the new compute entities connect to respective network devices. Additionally, role update messages can be used by network devices to update role mapping information maintained at other network devices as network addresses and/or roles of compute entities change.

Techniques or mechanisms according to some examples of the present disclosure improve computer functionality or the technology of network communications by allowing enforcement of role-based policies for compute entities at ingress network devices so that network bandwidth is not wasted in communicating data packets to egress network devices for policy enforcement. The ability to enforce role-based policies closer to sources of data packets allows for more efficient usage of network resources. For example, if a role-based policy specifies that a particular data packet from a source compute entity to a destination compute entity is to be dropped, then enforcing this role-based policy at the ingress network device (which is closer to the source of the data packet) means that the data packet can be dropped at the ingress network device before the data packet is transmitted further across a network. Reducing the amount of data traffic transferred across a network can also reduce the costs associated with data communications and reduce the resource usage of network devices.

A “network device” can refer to any electronic device that forwards data along network paths of a network. An example of a network device is a switch, which can forward data packets based on network addresses in the data packets. The switch can be a layer 2 switch that forwards a data packet based on a destination Media Access Control (MAC) address in the data packet. Alternatively, the switch can be a layer 3 router that forwards a data packet based on a source Internet Protocol (IP) address and a destination IP address in the data packet. A network device may also include a gateway, an access point (AP), or any other device for forwarding data.

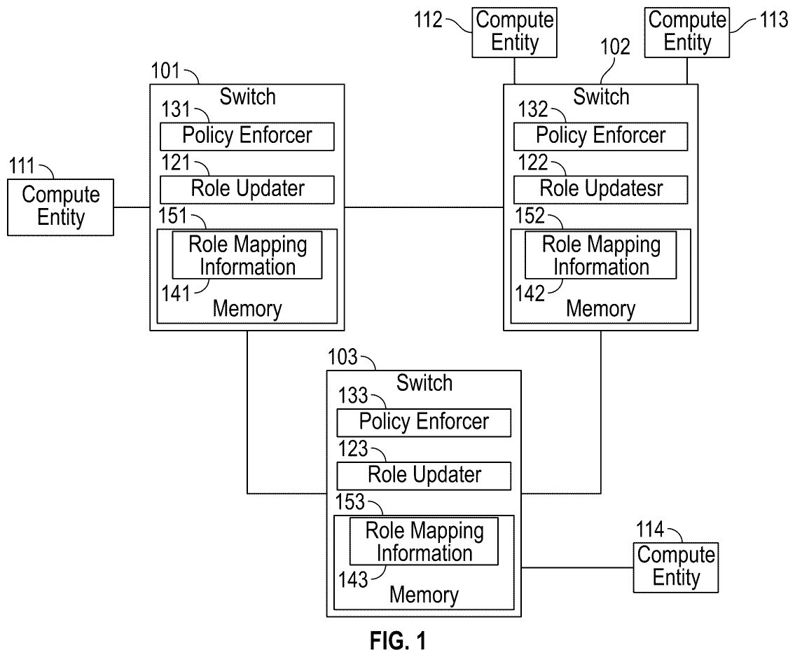

FIG. 1 is a block diagram of an example arrangement including switches 101, 102, and 103. A compute entity 111 is connected to the switch 101, compute entities 112 and 113 are connected to the switch 102, and a compute entity 114 is connected to the switch 103. Although specific quantities of switches and compute entities are shown in FIG. 1, in a different example, a different quantity of switches and/or compute entities may be present.

Although some examples refer to use of switches, techniques or mechanisms according to some examples of the present disclosure can be used in other types of network devices, such as gateways, APs, or another type of network device that transmits data along network paths from a source to a destination.

In some examples of the present disclosure, each switch includes a role updater and a policy enforcer. The role updater of a switch sends role update messages for compute entities connected to the switch. For example, as new compute entities are connected to the switch, the role updater can send role update messages to one or more other switches to provide role information of the compute entity to the other switch(es). In further examples, a role updater can send a role update message in response to either a change in a network address of a compute entity connected to the switch, or a change in a role of the compute entity, or a combination of both.

A policy enforcer is to enforce a role-based policy. In some examples, the role-based policy selected by the policy enforcer to apply to a data packet (or a collection of data packets) is based on a source role of a source compute entity that transmitted the data packet(s), and a destination role of a destination compute entity that is a target of the data packet(s).

The switch 101 includes a role updater 121 and a policy enforcer 131, the switch 102 includes a role updater 122 and a policy enforcer 132, and the switch 103 includes a role updater 123 and a policy enforcer 133. The role updater and policy enforcer in a switch can be implemented using hardware processing circuitry or machine-readable instructions executable by a processing resource of the switch.

Each switch stores role mapping information that correlates network addresses of compute entities to corresponding roles of the compute entities. The switch 101 stores role mapping information 141 in a memory 151 of the switch 101, the switch 102 stores role mapping information 142 in a memory 152 of the switch 102, and the switch 103 stores role mapping information 143 in a memory 153 of the switch 103.

A “role update message” can include one or more data packets, one or more information elements in a data packet, or any other type of information that can be exchanged between network devices such as switches. The role mapping information can be in the form of a table or any other type of data structure. The role mapping information can include multiple entries, where each entry correlates a network address of a compute entity to role information specifying a role of the compute entity. The role information may include a role identifier, for example. The role information may also include descriptive text of the role.

Table 1 below provides an example of entries of example role mapping information that may be included in a switch (e.g., any of 101 to 103).

TABLE 1

| Network Address | Role Information |
|---|---|
| Network Address 1 | Role A |
| Network Address 2 | Role B |
| Network Address 3 | Role C |
| Network Address 4 | Role B |

A first entry of the example role mapping information correlates network address 1 (MAC address 1 and/or IP address 1) to role A. This indicates that a compute entity assigned network address 1 (which can be a MAC address or an IP address) has role A. Similarly, other entries of the example role mapping information correlate network address 2 (MAC address 2 and/or IP address 2) to role B, network address 3 (MAC address 3 and/or IP address 3) to role C, and network address 4 (MAC address 4 and/or IP address 4) to role B.

The number of entries included in the role mapping information depends on how many compute entities a switch is aware of. As compute entities connect to a network, a given switch can add entries for the compute entities to the role mapping information as role update messages are received by the switch from other switches for the compute entities. Additionally, the given switch can add entries to the role mapping information as compute entities connect to the given switch.

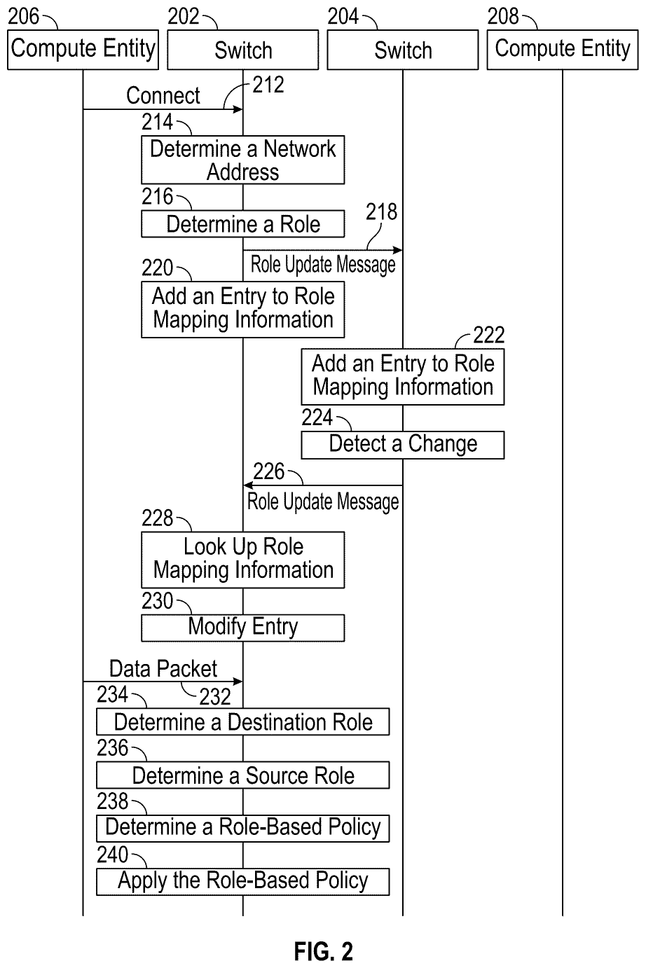

FIG. 2 is a flow diagram of a process involving switches 202 and 204 and compute entities 206 and 208. The switches 202 and 204 can be any two of the switches 101, 102, and 103 in FIG. 1, and the compute entities 206 and 208 can be any two of the compute entities 111, 112, 113, and 114 in FIG. 1.

The compute entity 206 can initially connect (at 212) to the switch 202. The connection of the compute entity 206 to the switch 202 can be a new network connection in which the compute entity 206 has not previously connected to the switch 202. For example, the compute entity 206 may have been onboarded to a network and connected to the switch 202. The connection may be a wired connection or a wireless connection. Alternatively, the compute entity may have been previously connected to the switch 202, but may have disconnected for some reason. In the latter example, the connection at 212 is a re-connection of the compute entity 206 to the switch 202.

The switch 202 determines (at 214) a network address of the compute entity 206. The determined network address may be a MAC address of the compute entity. If the compute entity 206 is a physical electronic device, then the MAC address may have been configured at the compute entity 206 at the time of manufacture. If the compute entity 206 is a virtual compute entity, then the MAC address may be dynamically assigned.

Alternatively or additionally, the determined network address may be an IP address of the compute entity 206. The switch 202 can determine the IP address of the compute entity 206 using any of various techniques. For example, the switch 202 may include an IP client tracker that probes a client (e.g., the compute entity 206) to determine a static IP address assigned the client. As another example, the switch 202 may perform Dynamic Host Configuration Protocol (DHCP) snooping to learn the IP address dynamically assigned the compute entity 206 by a DHCP server during a DHCP process.

The switch 202 also determines (at 216) a role of the compute entity 206. The switch 202 can obtain role information in various ways. In some examples, a role of a compute entity can be determined during an authentication process performed by the compute entity with an authentication server to authenticate the compute entity. The authentication process may be according to the Institute of Electrical and Electronics Engineers (IEEE) 802.1X standards. Role information for the compute entity can be provided by the authentication server, such as a Remote Authentication Dial-In User Service (RADIUS) server. A network device, such as the switch 202, uses the role information set by the authentication server to map the role of the compute entity to the network address of the compute entity.

In other examples, the switch 202 can obtain the role of the compute entity 206 using another technique. For example, the switch 202 can query another system, such as a management system of a network, for role information specifying the role of the compute entity 206.

A role updater in the switch 202 sends (at 218) a role update message to the switch 204. In some examples, the role update message sent by the switch 202 may be a broadcast message that may be sent by the switch 202 to multiple other switches.

In some examples, in addition to sending the role update message, the role updater in the switch 202 can also add (at 220) an entry to role mapping information in a memory of the switch 202, where the added entry correlates the network address of the compute entity 206 to role information of the compute entity 206. In other examples, the switch 202 may maintain a separate data structure correlating network addresses to roles of compute entities that are connected to the switch 202.

In response to the role update message, which contains the network address of the compute entity 206 and the role information for the compute entity 206, a role updater in the switch 204 adds (at 222) an entry to the role mapping information stored in a memory of the switch 204. The added entry correlates the network address of the compute entity 206 to the role information for the compute entity 206.

The compute entity 208 is connected to the switch 204. The compute entity 208 may have previously connected to the switch 204, and the switch 204 may have sent a role update message (not shown) to the switch 202, which can cause the switch 202 to update the role mapping information in the switch 202.

The switch 204 detects (at 224) a change in either the network address or the role (or both) of the compute entity 208. For example, the compute entity 208 when initially connected to the switch 204 may have been assigned a first IP address. Later, due to the compute entity 208 disconnecting or logging off from the network, and then re-connecting or logging on back to the network, the compute entity 208 may be assigned a different second IP address. The dynamic assignment of IP addresses can be part of a DHCP processes, in which a DHCP server can assign IP addresses to compute entities on a dynamic basis.

The role of the compute entity 208 may change for various reasons. For example, a user of the compute entity 208 may initially be part of a first department of an organization, but later, may change to a different department of the organization. Due to the change in departments, the role of the compute entity associated with the user may change. For example, the user moving from an engineering department to the finance department may result in the user being granted access to different collections of information or different resources.

Based on detecting the change in either the network address or the role (or both) of the compute entity 208, the switch 204 sends (at 226) a role update message containing the network address and role information of the compute entity 208 to the switch 202. The role update message may be a broadcast message sent to multiple other switches by the switch 204.

In response to the role update message from the switch 204, the switch 202 can perform a lookup (at 228) of its role mapping information to determine whether the role mapping information contains an entry for the compute entity 208. If so, the switch 202 can modify (at 230) the entry with the new network address and/or new role information of the compute entity 208.

Although not shown in FIG. 2, a change of a network address and/or a role of the compute entity 206 may be detected by the switch 202, which can send a role update message to one or more other switches in response.

The compute entity 206 may transmit (at 232) a data packet, where the data packet includes a destination network address (destination MAC address or destination IP address) that identifies the compute entity 208 as the destination of the data packet.

The switch 202 can determine (at 234) a destination role of the destination compute entity 208 by performing a lookup, based on the destination network address, of the role mapping information stored at the switch 202. The lookup identifies an entry of the role mapping information. The identified entry contains the role information specifying the role of the compute entity 208 (the destination role).

The switch 202 can also determine (at 236) a source role of the source compute entity 206 (the compute entity that transmitted the data packet) by performing a lookup of the role mapping information stored at the switch 202 or accessing another data structure that correlates network addresses to roles of compute entities connected to the switch 202. At this point, the switch 202 is aware of the source role of the source compute entity 206 and the destination role of the destination compute entity 208.

The switch 202 also maintains policy mapping information (e.g., as shown in Table 2 below) that correlates role combinations to respective role-based policies.

TABLE 2

| | Destination | Role-based |
|---|---|---|
| Source Role | Role | Policy |
| A | B | 1000 |
| A | C | 2000 |
| B | C | 3000 |

A first entry of the example policy mapping information of Table 2 correlates the combination of source role A and destination role B to role-based policy 1000. A second entry of Table 2 correlates the combination of source role A and destination role C to role-based policy 2000. A third entry of Table 2 correlates to the combination of source role B and destination role C to role-based policy 3000. Other entries of the example policy mapping information can correlate other role combinations to other role-based policies.

Based on a lookup of the policy mapping information using the source role and the destination role, a policy enforcer in the switch 202 retrieves an entry of the role mapping information corresponding to the source role of the compute entity 206 and the destination compute entity 208. The policy enforcer in the switch 202 determines (at 238) the role-based policy to apply from the identified entry of the policy mapping information.

The policy enforcer in the switch 202 (which is the ingress switch for the source compute entity 206) applies (at 240) the role-based policy at the switch 202. The role-based policy may specify that the data packet is to be dropped. Alternatively, the role-based policy may specify another action with respect to the data packet, including forwarding the data packet, modifying the data packet, or any other action with respect to the data packet.

If the policy mapping information does not include an entry for the destination network address of the data packet received from the source compute entity 206, then the switch 202 would forward the data packet towards the destination. In this case, enforcement of a group-based policy would be performed at the egress switch connected to the destination compute entity 208.

In some examples, virtual tunnels can be established between the switches 101, 102, and 103 of FIG. 1. A virtual tunnel can carry data according to a first communication protocol as payload within a data packet of a different second communication protocol. A “virtual tunnel” can refer to a communication path over a network in which data packets are encapsulated before being transmitted.

In some examples, a virtual tunnel includes a Virtual Extensible Local Area Network (VXLAN) tunnel. According to the VXLAN protocol, a VXLAN tunnel encapsulates Layer 2 frames of a Layer 2 overlay network as payloads in Layer 3 packets. The Layer 3 packets are communicated through a Layer 3 underlay network. A network in which frames of a Layer 2 overlay network are carried over a Layer 3 underlay network is referred to as an “underlay and overlay network.” An example of the Layer 3 underlay network is an IP network that transfers data in data packets. An example of the Layer 2 overlay network is an Ethernet network that transfers data in Ethernet frames. In such examples, the VXLAN tunnel can encapsulate an Ethernet frame as a payload in an IP data packet.

A network device, such as a switch or another type of network device that forwards data, can include a data plane entity that performs VXLAN encapsulation and decapsulation. Such a data plane entity is referred to as a VXLAN tunnel endpoint (VTEP). The VTEP is part of the data plane of the underlay and overlay network used for forwarding data by the network device. A policy enforcer of a switch can be part of the VTEP.

The network device also includes a control plane entity (that is part of a control plane of the underlay and overlay network) that exchanges control information with other network devices to enable forwarding of data by the network devices. In some examples, the control plane of the underlay and overlay network can operate according to the Ethernet Virtual Private Network (EVPN) technology.

Although reference is made to EVPN and VXLAN in some examples for establishing virtual tunnels between network devices, it is noted that in other examples, other types of virtual tunnel technologies may be employed, whether open source, standardized, or proprietary. Examples of other virtual tunnel technologies include the following: a Multiprotocol Label Switching (MPLS)-over-Generic Routing Encapsulation (GRE) technology, a Network Virtualization using GRE (NVGRE) technology, or any other technology for establishing virtual tunnels.

In further examples, virtual tunnels are not used among switches of a network.

Role update messages exchanged between switches can include messages according to a Border Gateway Protocol (BGP), which supports routing among different domains. In some examples, a network environment can be partitioned into domains in which entities are able to communicate with one another over a network. Switches that exchange BGP messages with one another are referred to as peer switches.

Traffic between entities in different domains is passed through respective gateway devices of the different domains. Examples of different domains include different data centers, different campuses, different geographic sites, different communication fabrics, or any other types of domains. In examples where a network environment is partitioned into domains, the switches 101, 102, and 103 of FIG. 1 may be part of different domains and may communicate with one another through gateway devices (not shown) of the domains.

In other examples, role update messages sent between switches for communicating role information of compute entities can be according to other protocols, whether standardized, open source, or proprietary.

In examples where BGP update messages are used to carry role information of compute entities (such as the role update messages sent at 218 and 226 in FIG. 2), each BGP update message may include an optional custom Path Attribute. For example, the custom Path Attribute may include an attribute value made up of a number of bytes to carry a network address and a number of bytes to carry role information. The role information in the attribute value may be in the form of a Policy Option (GPO) identifier, for example. The custom Path Attribute may be identified by an attribute type code that is set to a value to identify a vendor-specific attribute, and can include an attribute length field that specifies a length of the attribute value in the custom Path Attribute.

A BGP update message can include one or more custom Path Attributes. Multiple custom Path Attributes are included in a BGP update message carry network address and role information for different compute entities.

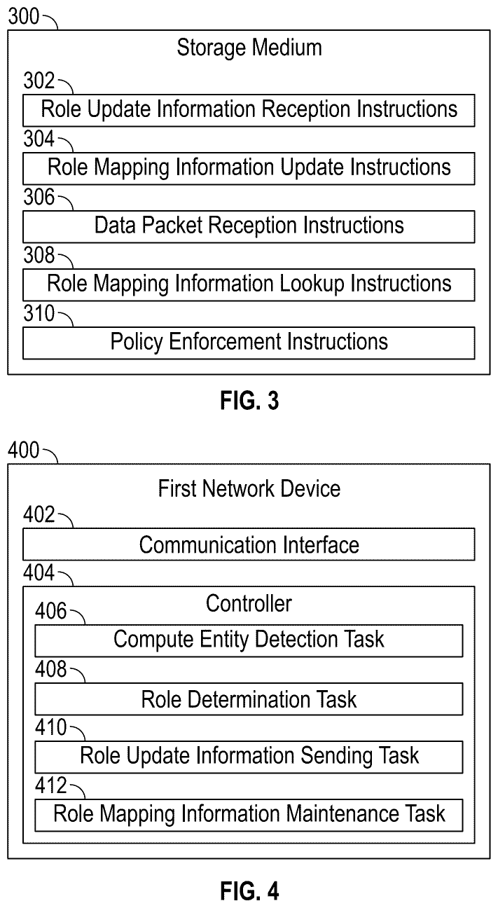

FIG. 3 is a block diagram of a non-transitory machine-readable or computer-readable storage medium 300 storing machine-readable instructions that upon execution cause a first network device to perform various tasks. The first network device may be any of the switches 101 to 103 of FIG. 1, or any other type of network device.

The machine-readable instructions include role update information reception instructions 302 to receive, from a second network device, role update information for a compute entity connected to the second network device. The role update information includes role information specifying a role of the compute entity and a network address of the compute entity. The second network device may be a switch or any other type of network device. The network address may include a MAC address and/or an IP address of the compute entity.

The machine-readable instructions include role mapping information update instructions 304 to update role mapping information stored at the first network device based on the received role update information, where the role mapping information correlates network addresses to roles of compute entities. The updating includes adding an entry to the role mapping information, where the added entry correlates the network address of the compute entity to the role information of the compute entity.

The machine-readable instructions include data packet reception instructions 306 to receive, at the first network device from a first compute entity, a data packet containing a destination network address of a second compute entity to which the data packet is targeted.

The machine-readable instructions include role mapping information lookup instructions 308 to perform a lookup of the role mapping information using the destination network address to determine a role of the second compute entity. The lookup can retrieve an entry from the role mapping information, where the retrieved entry correlates the network address of the second compute entity to role information of the second compute entity.

The machine-readable instructions include policy enforcement instructions 310 to enforce a policy with respect to the data packet at the first network device based on a role of the first compute entity and the role of the second compute entity. The policy enforcement occurs at the first network device that is an ingress network device for the first compute entity.

In some examples, the second compute entity is connected to a network device (an egress network device) that is different from the first network device.

In some examples, the first network device sends, to the second network device, role update information including a network address of the first compute entity and the role of the first compute entity, such as in response to detecting a connection of the first compute entity to the first network device. The second network device uses the role update information sent by the first network device to add an entry to role mapping information maintained at the second network device.

In some examples, the network address of the first compute entity includes an IP address of the first compute entity. The first network device learns the IP address of the first compute entity, and learns the role of the first compute entity.

In some examples, the role update information including the network address of the first compute entity and the role information of the first compute entity is included in a role update message sent from the second network device to the first network device.

In some examples, the update message comprises a BGP update message or any other type of update message.

In some examples, the role update information including the network address of the first compute entity and the role information of the first compute entity is included in a custom Path Attribute of the BGP update message.

In some examples, the role update message contains the network address of the first compute entity and the role information of the first compute entity, and a network address of a further compute entity and role information of the further compute entity, the further compute entity connected to the first network device.

In some examples, the first network device detects an updated network address or an updated role of the first compute entity. In response to detecting the updated network address or the updated role, the first network device sends further role update information from the first network device to one or more other network devices, the further role update information containing the updated network address or the updated role.

In some examples, the enforcement of the policy is applied by a virtual tunnel endpoint (VTEP) in an ingress switch,

In some examples, the first network device receives, from the first compute entity or another compute entity, a further data packet containing a further destination network address of a third compute entity to which the data packet is targeted. The first network device performs a lookup of the role mapping information using the further destination network address. The first network device determines that the role mapping information is without role information for the third compute entity. Based on determining that the role mapping information is without role information for the third compute entity, the first network device transmits the further data packet to another network device connected to the third compute entity.

In some examples, the transmitting of the further data packet by the first network device is performed without applying a role-based policy enforcement at the first network device with respect to the further data packet.

FIG. 4 is a block diagram of a first network device 400 according to some examples of the present disclosure. The first network device 400 includes a communication interface 402 to communicate with one or more other network devices. The communication interface 402 can include a signal transceiver to transmit and receive signals, and one or more protocol layers to manage communications of data according to one or more communication protocols, such as the MAC protocol, IP protocol, and so forth.

The first network device 400 includes a controller 404 to perform various tasks. A “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on the one or more hardware processing circuits.

The tasks of the controller 404 include a compute entity detection task 406 to detect a connection of a first compute entity to the first network device 400. For example, the first compute entity may have been newly onboarded in a network and has connected to the first network device 400.

The tasks of the controller 404 include a role determination task 408 to determine a role of the first compute entity. The controller 404 can detect the role of the first compute entity during an authentication process performed by the first compute entity with an authentication server, where the authentication server assigns the role of the first compute entity. Alternatively, the controller 404 may obtain the role of the first compute entity from a management system or using another technique.

The tasks of the controller 404 include a role update information sending task 410 to send, from the first network device to the one or more other network devices, role update information for the first compute entity. The role update information includes role information specifying a role of the first compute entity and a network address of the first compute entity. For example, the role update information includes a role update message.

The tasks of the controller 404 include a role mapping information maintenance task 412 to maintain, at the first network device, role mapping information correlating network addresses of compute entities to roles of the compute entities.

In some examples, the controller 404 receives, at the first network device from a second network device, further role update information for a second compute entity connected to the second network device. The further role update information includes role information specifying a role of the second compute entity and a network address of the second compute entity. The controller 404 updates the role mapping information at the first network device based on the further role update information, the updating including adding an entry correlating the network address of the second compute entity to the role information of the second compute entity.

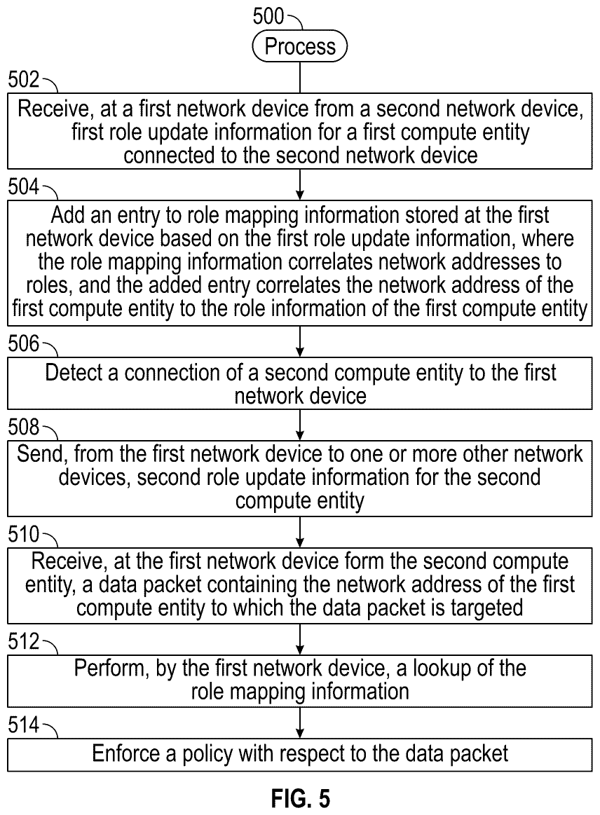

FIG. 5 is a flow diagram of a process 500 according to some examples of the present disclosure. The process 500 can be performed by a first network device, which may be any of the switches 101 to 103 of FIG. 1 or any other type of network device.

The process 500 includes receiving (at 502), at the first network device from a second network device, first role update information for a first compute entity connected to the second network device, the first role update information including role information specifying a role of the first compute entity and a network address of the compute entity. The first role update information may include a first role update message, such as a BGP update message or any other type of update message.

The process 500 includes adding (at 504) an entry to role mapping information stored at the first network device based on the first role update information, where the role mapping information correlates network addresses to roles, and the added entry correlates the network address of the first compute entity to the role information of the first compute entity.

The process 500 includes detecting (at 506) a connection of a second compute entity to the first network device. The connection may be a wired connection or a wireless connection.

The process 500 includes sending (at 508), from the first network device to one or more other network devices, second role update information for the second compute entity, the second role update information including role information specifying a role of the second compute entity and a network address of the second compute entity. The second role update information may include a broadcast update message.

The process 500 includes receiving (at 510), at the first network device from the second compute entity, a data packet containing the network address of the first compute entity to which the data packet is targeted. The second compute entity is the source compute entity and the first compute entity is the destination compute entity.

The process 500 includes performing (at 512), by the first network device, a lookup of the role mapping information using the network address of the first compute entity to determine a role of the first compute entity. The lookup retrieves an entry from the role mapping information, and the retrieved entry correlates the network address of the first compute entity to the role information of the first compute entity.

The process 500 includes enforcing (at 514) a policy with respect to the data packet at the first network device based on the role of the first compute entity and the role of the second compute entity.

As used here, an “electronic device” can refer to any or some combination of a desktop computer, a notebook computer, a tablet computer, a server computer, a smartphone, an appliance, an Internet-of-Things (IoT) device, a vehicle, or any other type of electronic.

A “processing resource” can include one or more hardware processors. A hardware processor can include a microprocessor, a core of a multi-core microprocessor, a microcontroller, a programmable integrated circuit, a programmable gate array, or another hardware processing circuit.

A memory can be implemented using one or more memory devices. A memory device can include any or some combination of the following: a dynamic or static random access memory (a DRAM or SRAM) device, an erasable and programmable read-only memory (EPROM) device, an electrically erasable and programmable read-only memory (EEPROM) device, or a flash memory device.

Although FIGS. 2 and 5 show respective orders of tasks, in other examples, the tasks of a process may be performed in a different order, some tasks may be omitted, and other tasks may be added.

A storage medium (e.g., 300 in FIG. 3) can include any or some combination of the following: a semiconductor memory device such as a DRAM or SRAM, an EPROM, an EEPROM, or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a first network device to:
receive, from a second network device, role update information for a compute entity connected to the second network device, the role update information comprising role information specifying a role of the compute entity and a network address of the compute entity;
update role mapping information stored at the first network device based on the received role update information, wherein the role mapping information correlates network addresses to roles;
receive, at the first network device from a first compute entity, a data packet containing a destination network address of a second compute entity to which the data packet is targeted;
perform a lookup of the role mapping information using the destination network address to determine a role of the second compute entity; and
enforce a policy with respect to the data packet at the first network device based on a role of the first compute entity and the role of the second compute entity.

2. The non-transitory machine-readable storage medium of claim 1, wherein the second compute entity is connected to a network device that is different from the first network device.

3. The non-transitory machine-readable storage medium of claim 1, wherein the instructions upon execution cause the first network device to:
send, from the first network device to the second network device, role update information comprising a network address of the first compute entity and the role of the first compute entity.

4. The non-transitory machine-readable storage medium of claim 3, wherein the network address of the first compute entity comprises an Internet Protocol (IP) address of the first compute entity, and wherein the instructions upon execution cause the first network device to:
learn the IP address of the first compute entity; and
learn the role of the first compute entity.

5. The non-transitory machine-readable storage medium of claim 3, wherein the role update information comprising the network address of the first compute entity and the role information of the first compute entity is included in a role update message sent from the second network device to the first network device.

6. The non-transitory machine-readable storage medium of claim 5, wherein the update message comprises a Border Gateway Protocol (BGP) update message.

7. The non-transitory machine-readable storage medium of claim 6, wherein the role update information comprising the network address of the first compute entity and the role information of the first compute entity is included in a custom Path Attribute of the BGP update message.

8. The non-transitory machine-readable storage medium of claim 5, wherein the role update message contains:
the network address of the first compute entity and the role information of the first compute entity, and
a network address of a further compute entity and role information of the further compute entity, the further compute entity connected to the first network device.

9. The non-transitory machine-readable storage medium of claim 3, wherein the instructions upon execution cause the first network device to:
detect an updated network address or an updated role of the first compute entity; and
in response to detecting the updated network address or the updated role, send further role update information from the first network device to one or more other network devices, the further role update information containing the updated network address or the updated role.

10. The non-transitory machine-readable storage medium of claim 1, wherein the first network device is an ingress switch for the data packet sent from the first compute entity.

11. The non-transitory machine-readable storage medium of claim 10, wherein the enforcement of the policy is applied by a virtual tunnel endpoint (VTEP) in the ingress switch.

12. The non-transitory machine-readable storage medium of claim 1, wherein the instructions upon execution cause the first network device to:
receive, at the first network device from the first compute entity or another compute entity, a further data packet containing a further destination network address of a third compute entity to which the data packet is targeted;
perform a lookup of the role mapping information using the further destination network address;
determine that the role mapping information is without role information for the third compute entity; and
based on determining that the role mapping information is without role information for the third compute entity, transmit, from the first network device, the further data packet to another network device connected to the third compute entity.

13. The non-transitory machine-readable storage medium of claim 12, wherein the transmitting of the further data packet by the first network device is performed without applying a role-based policy enforcement at the first network device with respect to the further data packet.

14. A first network device comprising:
a communication interface to communicate with one or more other network devices; and
a controller to:
detect a connection of a first compute entity to the first network device;
determine a role of the first compute entity;
send, from the first network device to the one or more other network devices, role update information for the first compute entity, the role update information comprising role information specifying a role of the first compute entity and a network address of the first compute entity; and
maintain, at the first network device, role mapping information correlating network addresses of compute entities to roles of the compute entities.

15. The first network device of claim 14, wherein the controller is to:
receive, at the first network device from a second network device, further role update information for a second compute entity connected to the second network device, the further role update information comprising role information specifying a role of the second compute entity and a network address of the second compute entity;
update the role mapping information at the first network device based on the further role update information, the updating comprising adding an entry correlating the network address of the second compute entity to the role information of the second compute entity.

16. The first network device of claim 15, wherein the controller is to:
receive, at the first network device from the first compute entity, a data packet containing the network address of the second compute entity to which the data packet is targeted;
perform a lookup of the role mapping information using the network address of the second compute entity to determine the role of the second compute entity; and
enforce a policy with respect to the data packet at the first network device based on the role of the first compute entity and the role of the second compute entity.

17. The first network device of claim 14, wherein the controller is to:
detect an updated network address or an updated role of the first compute entity; and
in response to detecting the updated network address or the updated role, send further role update information from the first network device to the one or more other network devices, the further role update information containing the updated network address or the updated role.

18. The first network device of claim 14, wherein the role update information comprises a role update message containing an attribute comprising the role information and the network address of the first compute entity.

19. A method comprising:
receiving, at a first network device from a second network device, first role update information for a first compute entity connected to the second network device, the first role update information comprising role information specifying a role of the first compute entity and a network address of the first compute entity;
adding an entry to role mapping information stored at the first network device based on the first role update information, wherein the role mapping information correlates network addresses to roles, and the added entry correlates the network address of the first compute entity to the role information of the first compute entity;
detecting a connection of a second compute entity to the first network device;
sending, from the first network device to one or more other network devices, second role update information for the second compute entity, the second role update information comprising role information specifying a role of the second compute entity and a network address of the second compute entity
receiving, at the first network device from the second compute entity, a data packet containing the network address of the first compute entity to which the data packet is targeted;
performing, by the first network device, a lookup of the role mapping information using the network address of the first compute entity to determine a role of the first compute entity; and
enforcing a policy with respect to the data packet at the first network device based on the role of the first compute entity and the role of the second compute entity.

20. The method of claim 19, wherein the network address of the first compute entity in the added entry comprises one or both of a Media Access Control (MAC) address or an Internet Protocol (IP) address.
